(19) United States
(12) Patent Application Publication
(10) Pub. No.: US 2015/0271226 A1
(43) Pub. Date: Sep. 24, 2015

(54) TRANSPORT ACCELERATOR IMPLEMENTING A MULTIPLE INTERFACE ARCHITECTURE

(71) Applicant: QUALCOMM Incorporated, San Diego, CA (US)

(72) Inventors: Michael George Luby, Berkeley, CA (US); Lorenz Christoph Minder, Evanston, IL (US); Fatih Ulupinar, San Diego, CA (US); Yinian Mao, San Diego, CA (US); Deviprasad Putchala, San Diego, CA (US)

(73) Assignee: QUALCOMM Incorporated, San Diego, CA (US)

(21) Appl. No.: 14/289,476

(22) Filed: May 28, 2014

Related U.S. Application Data
(60) Provisional application No. 61/955,003, filed on Mar. 18, 2014.

(51) Int. Cl. H04L 29/06; H04L 12/803; H04L 29/08

(52) U.S. Cl. CPC H04L 65/4084; H04L 67/02; H04L 47/125; H04L 65/105

(57) ABSTRACT

Transport accelerator (TA) systems and methods for accelerating delivery of content to a user agent (UA) of the client device are provided according to embodiments of the present disclosure. Embodiments initiate media transmission operation for the UA using the TA disposed in a communication path between the UA and a content server operable to provide content, wherein the TA comprises a request manager (RM) operable to control what data is requested from the content server and a plurality of connection managers (CMs) operable to control when the data is requested from the content server, wherein each CM of the plurality of CMs is adapted for communication with the content server via a different communication interface.

### PRIORITY AND RELATED APPLICATIONS STATEMENT

The present application claims priority to co-pending U.S. Provisional Patent Application No. 61/955,003, entitled “TRANSPORT ACCELERATOR IMPLEMENTING A MULTIPLE INTERFACE ARCHITECTURE,” filed Mar. 18, 2014, the disclosure of which is hereby incorporated herein by reference. This application is related to commonly assigned U.S. patent application Ser. No. [Docket Number QLXX.PO446US (133355U1)] entitled “TRANSPORT ACCELERATOR IMPLEMENTING EXTENDED TRANSMISSION CONTROL FUNCTIONALITY,” Ser. No. [Docket Number QLXX.PO446US.B (133355U2)] entitled “TRANSPORT ACCELERATOR IMPLEMENTING EXTENDED TRANSMISSION CONTROL FUNCTIONALITY,” Ser. No. [Docket Number QLXX.PO447US (140058)] entitled “TRANSPORT ACCELERATOR IMPLEMENTING ENHANCED SIGNALING,” Ser. No. [Docket Number QLXX.PO448US (140059)] entitled “TRANSPORT ACCELERATOR IMPLEMENTING REQUEST MANAGER AND CONNECTION MANAGER FUNCTIONALITY,” Ser. No. [Docket Number QLXX.PO449US (140060)] entitled “TRANSPORT ACCELERATOR IMPLEMENTING SELECTIVE UTILIZATION OF REDUNDANT ENCODED CONTENT DATA FUNCTIONALITY,” and Ser. No. [Docket Number QLXX.PO451US (140062)] entitled “TRANSPORT ACCELERATOR IMPLEMENTING CLIENT SIDE TRANSMISSION FUNCTIONALITY,” each of which being concurrently filed herewith and the disclosures of which are expressly incorporated by reference herein in their entirety.

### DESCRIPTION OF THE RELATED ART

More and more content is being transferred over available communication networks. Often, this content includes numerous types of data including, for example, audio data, video data, image data, etc. Video content, particularly high resolution video content, often comprises a relatively large data file or other collection of data. Accordingly, a user agent (UA) on an end user device or other client device which is consuming such content often requests and receives a sequence of fragments of content comprising the desired video content. For example, a UA may comprise a client application or process executing on a user device that requests data, often multimedia data, and receives the requested data for further processing and possibly for display on the user device.

Many types of applications today rely on HTTP for the foregoing content delivery. In many such applications the performance of the HTTP transport is critical to the user's experience with the application. For example, live streaming has several constraints that can hinder the performance of a video streaming client. Two constraints stand out particularly. First, media segments become available one after another over time. This constraint prevents the client from continuously downloading a large portion of data, which in turn affects the accuracy of download rate estimate. Since most streaming clients operate on a “request-download-estimate”, loop, it generally does not do well when the download estimate is inaccurate. Second, when viewing a live event streaming, users generally don't want to suffer a long delay from the actual live event timeline. Such a behavior prevents the streaming client from building up a large buffer, which in turn may cause more rebuffering.

Where the streaming client operates over Transport Control Protocol (TCP) (as most Dynamic Adaptive Streaming over HTTP (DASH) clients do), the client typically requests fragments based upon an estimated availability schedule. Such requests are generally made using one or more TCP ports, with little or no management of the particular ports serving particular fragment requests etc. Moreover, although multiple ports for providing multiple connections through a common interface (e.g., each such connection being made via a WiFi interface), concurrent support for multiple different interfaces (e.g., 4^{th} Generation/Long Term Evolution (4G/LTE) and Wireless Fidelity (WiFi)), particularly for requesting and receiving fragments for the same source content, or portions of the same fragments, via different interfaces, is not supported.

### SUMMARY

A method for accelerating, by a transport accelerator (TA) of a client device, delivery of content to a user agent (UA) of the client device is provided according to embodiments of the present disclosure. The method according to embodiments includes initiating media transmission operation for the UA using the TA disposed in a communication path between the UA and a content server operable to provide content, wherein the TA comprises a request manager (RM) operable to control what data is requested from the content server and a plurality of connection managers (CMs) operable to control when the data is requested from the content server, wherein each CM of the plurality of CMs is adapted for communication with the content server via a different communication interface. The method of embodiments further includes requesting, by the RM, one or more chunks of the content from a first CM of the plurality of CMs, and receiving, by the RM, data sent in response to the requesting one or more chunks of the content from the first CM.

An apparatus configured for accelerating, by a transport accelerator (TA) of a client device, delivery of content to a user agent (UA) of the client device is provided according to embodiments of the present disclosure. The apparatus according to embodiments includes means for initiating media transmission operation for the UA using the TA disposed in a communication path between the UA and a content server operable to provide content, wherein the TA comprises a request manager (RM) operable to control what data is requested from the content server and a plurality of connection managers (CMs) operable to control when the data is requested from the content server, wherein each CM of the plurality of CMs is adapted for communication with the content server via a different communication interface. The apparatus of embodiments further includes means for requesting, by the RM, one or more chunks of the content from a first CM of the plurality of CMs, and means for receiving, by the RM, data sent in response to the requesting one or more chunks of the content from the first CM.

A computer program product for accelerating, by a transport accelerator (TA) of a client device, delivery of content to a user agent (UA) of the client device is provided according to embodiments of the present disclosure. The computer program product according to embodiments includes a non-transitory computer-readable medium having program code recorded thereon. The program code of embodiments includes program code to initiate media transmission operation for the UA using the TA disposed in a communication path between the UA and a content server operable to provide content, wherein the TA comprises a request manager (RM) operable to control what data is requested from the content server and a plurality of connection managers (CMs) operable to control when the data is requested from the content server, wherein each CM of the plurality of CMs is adapted for communication with the content server via a different communication interface. The program code of embodiments further includes program code to request, by the RM, one or more chunks of the content from a first CM of the plurality of CMs, and program code to receive, by the RM, data sent in response to the requesting one or more chunks of the content from the first CM.

An apparatus configured for accelerating, by a transport accelerator (TA) of a client device, delivery of content to a user agent (UA) of the client device is provided according to embodiments of the present disclosure. The apparatus of embodiments includes at least one processor, and a memory coupled to the at least one processor. The at least one processor is configured according to embodiments to initiate media transmission operation for the UA using the TA disposed in a communication path between the UA and a content server operable to provide content, wherein the TA comprises a request manager (RM) operable to control what data is requested from the content server and a plurality of connection managers (CMs) operable to control when the data is requested from the content server, wherein each CM of the plurality of CMs is adapted for communication with the content server via a different communication interface. The at least one processor is further configured according to embodiments to request, by the RM, one or more chunks of the content from a first CM of the plurality of CMs, and to receive, by the RM, data sent in response to the requesting one or more chunks of the content from the first CM.

### BRIEF DESCRIPTION OF THE DRAWINGS

FIGS. 1A and 1B show systems adapted for transport acceleration operation according to embodiments of the present disclosure.

FIG. 1C shows detail with respect to embodiments of a request manager and connection manager as may be implemented with respect to configurations of a transport accelerator according to embodiments of the present disclosure.

FIG. 1D shows detail with respect to embodiments of an interface provided between a request manager and connection manager as may be implemented with respect to configurations of a transport accelerator according to embodiments of the present disclosure.

FIG. 2 shows a flow diagram of operation wherein a Request Manager operates with respect to a plurality of Connection Managers according to embodiments of the present disclosure.

FIG. 3 shows operation using a plurality of network interfaces where a client device is moving through coverage areas according to embodiments of the present disclosure.

FIG. 4 shows a Transport Accelerator proxy configuration according to embodiments of the present disclosure.

FIG. 5 shows a system configuration including a plurality of Transport Accelerator proxies as may be utilized according to embodiments of the present disclosure.

FIG. 6 shows a system configuration wherein a plurality of Transport Accelerator helper devices are utilized according to embodiments of the present disclosure.

### DETAILED DESCRIPTION

The word “exemplary” is used herein to mean “serving as an example, instance, or illustration.” Any aspect described herein as “exemplary” is not necessarily to be construed as preferred or advantageous over other aspects.

In this description, the term “application” may also include files having executable content, such as: object code, scripts, byte code, markup language files, and patches. In addition, an “application” referred to herein, may also include files that are not executable in nature, such as documents that may need to be opened or other data files that need to be accessed.

As used in this description, the term “content” may include data having video, audio, combinations of video and audio, or other data at one or more quality levels, the quality level determined by bit rate, resolution, or other factors. The content may also include executable content, such as: object code, scripts, byte code, markup language files, and patches. In addition, “content” may also include files that are not executable in nature, such as documents that may need to be opened or other data files that need to be accessed.

As used in this description, the term “fragment” refers to one or more portions of content that may be requested by and/or received at a user device.

As used in this description, the term “streaming content” refers to content that may be sent from a server device and received at a user device according to one or more standards that enable the real-time transfer of content or transfer of content over a period of time. Examples of streaming content standards include those that support de-interleaved (or multiple) channels and those that do not support de-interleaved (or multiple) channels.

As used in this description, the terms “component,” “database,” “module,” “system,” and the like are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device may be a component. One or more components may reside within a process and/or thread of execution, and a component may be localized on one computer and/or distributed between two or more computers. In addition, these components may execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

As used herein, the terms “user equipment,” “user device,” and “client device” include devices capable of requesting and receiving content from a web server and transmitting information to a web server. Such devices can be a stationary devices or mobile devices. The terms “user equipment,” “user device,” and “client device” can be used interchangeably.

As used herein, the term “user” refers to an individual receiving content on a user device or on a client device and transmitting information to a website.

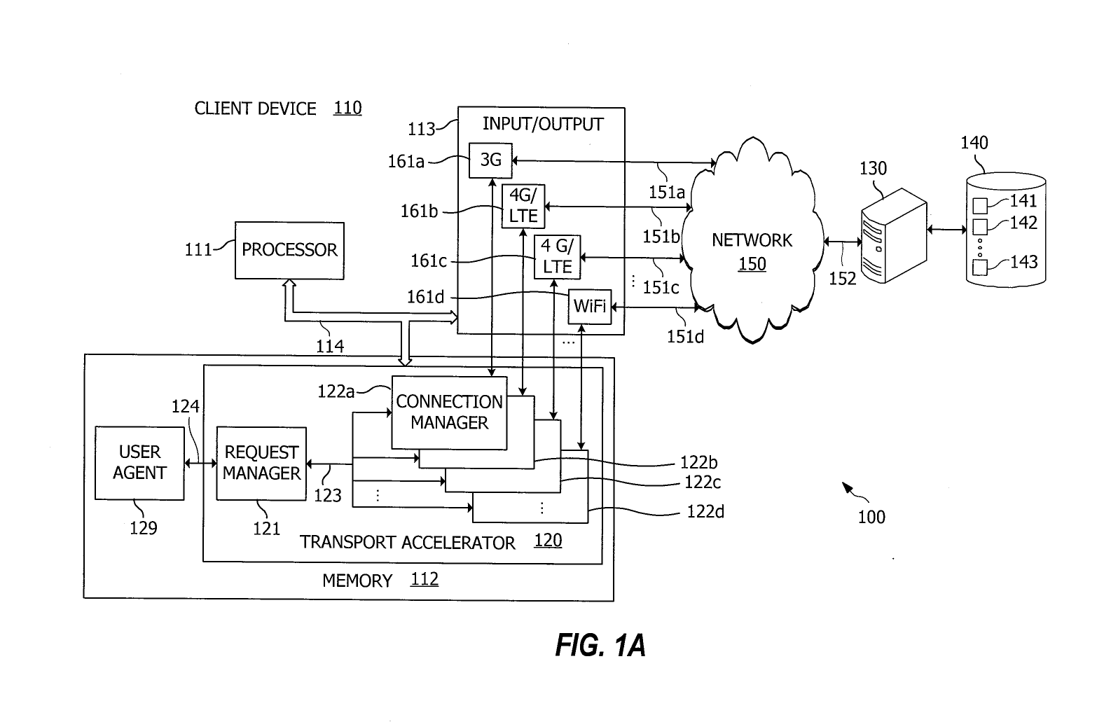

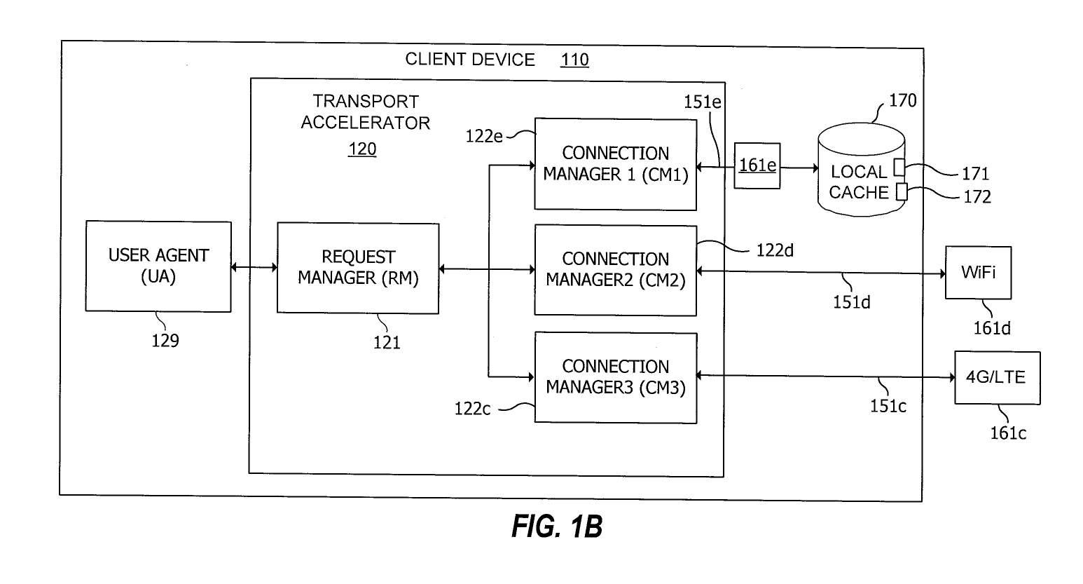

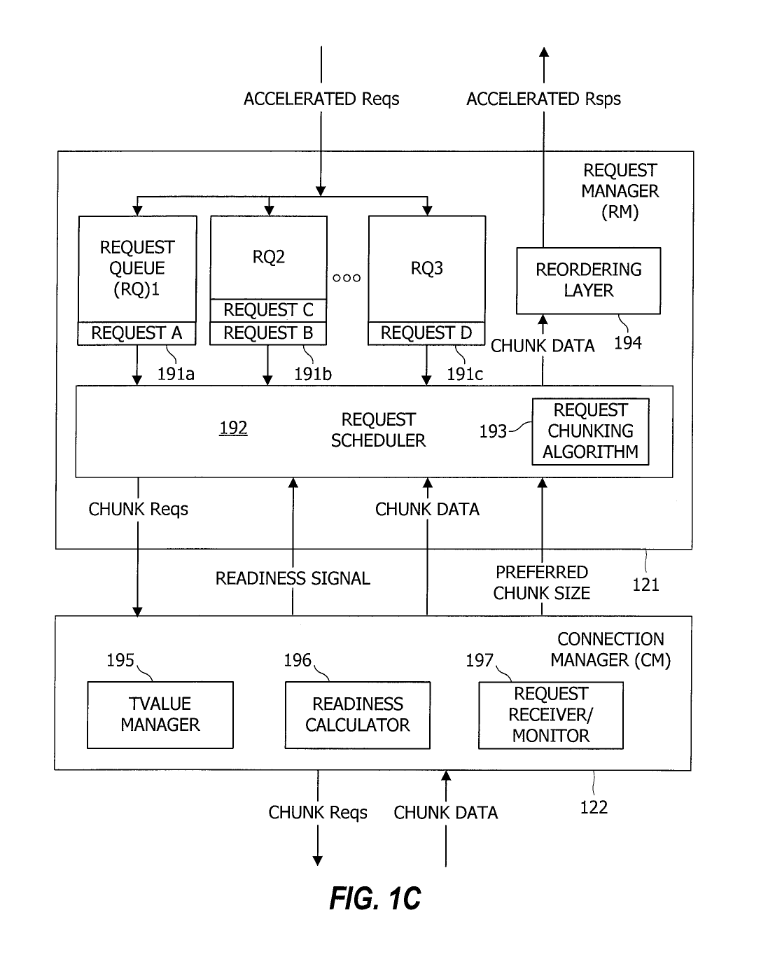

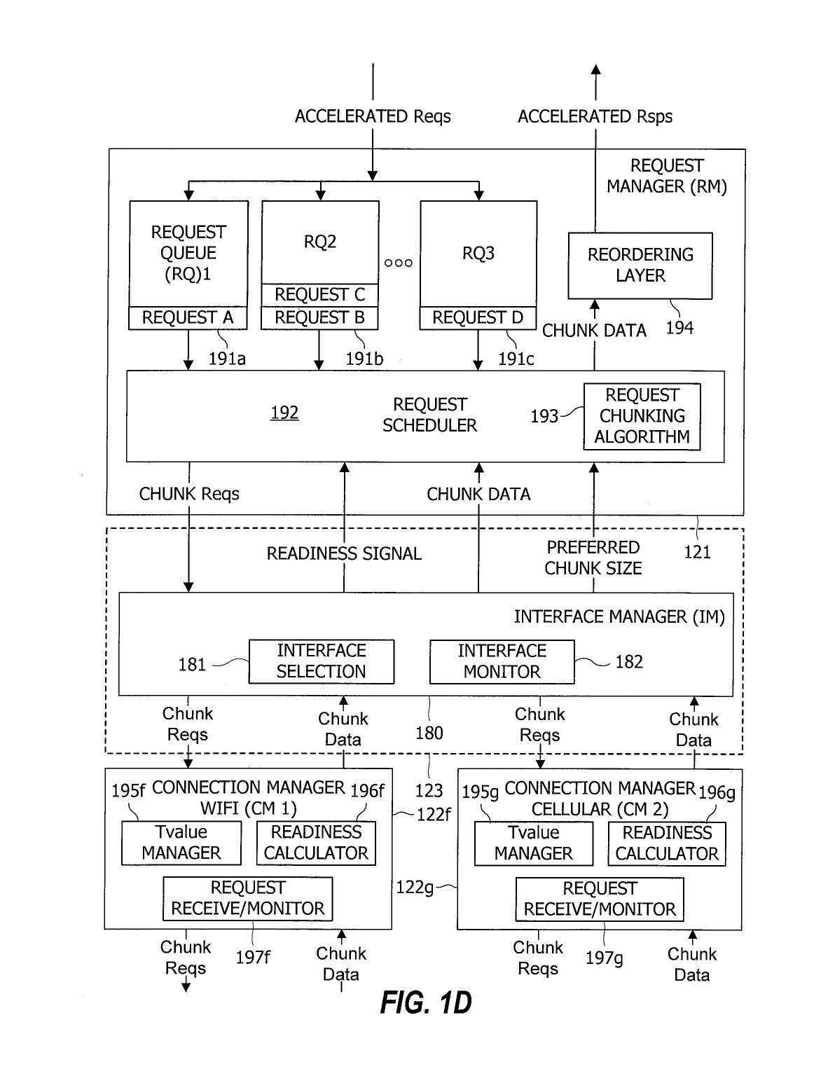

FIG. 1A shows system 100 adapted according to the concepts herein to provide transfer of content, such as may comprise audio data, video data, image data, file data, etc., over communication networks. Accordingly, client device 110 is shown in communication with server 130 via network 150, whereby server 130 may transfer various content stored in database 140 to client device 110 in accordance with the concepts of the present disclosure. It should be appreciated that, although only a single client device and a single server and database are represented in FIG. 1A, system 100 may comprise a plurality of any or all such devices. For example, server 130 may comprise a server of a server farm, wherein a plurality of servers may be disposed centrally and/or in a distributed configuration, to serve high levels of demand for content transfer. Alternatively, server 130 may be collocated on the same device as transport accelerator 120 (e.g., connected to transport accelerator 120 directly through I/O element 113, instead of through network 150) such as when some or all of the content resides in a database 140 (cache) that is also collocated on the device and provided to transport accelerator 120 through server 130. Likewise, users may possess a plurality of client devices and/or a plurality of users may each possess one or more client devices, any or all of which are adapted for content transfer according to the concepts herein.

Client device 110 may comprise various configurations of devices operable to receive transfer of content via network 150. For example, client device 110 may comprise a wired device, a wireless device, a personal computing device, a tablet or pad computing device, a portable cellular telephone, a WiFi enabled device, a Bluetooth enabled device, a television, a pair of glasses having a display, a pair of augmented reality glasses, or any other communication, computing or interface device connected to network 150 which can communicate with server 130 using any available methodology or infrastructure. Client device 110 is referred to as a “client device” because it can function as, or be connected to, a device that functions as a client of server 130.

Client device 110 of the illustrated embodiment comprises a plurality of functional blocks, shown here as including processor 111, memory 112, and input/output (I/O) element 113. Although not shown in the representation in FIG. 1A for simplicity, client device 110 may comprise additional functional blocks, such as a user interface, a radio frequency (RF) module, a camera, a sensor array, a display, a video player, a browser, etc., some or all of which may be utilized by operation in accordance with the concepts herein. The foregoing functional blocks may be operatively connected over one or more buses, such as bus 114. Bus 114 may comprises the logical and physical connections to allow the connected elements, modules, and components to communicate and interoperate.

Memory 112 can be any type of volatile or non-volatile memory, and in an embodiment, can include flash memory. Memory 112 can be permanently installed in client device 110, or can be a removable memory element, such as a removable memory card. Although shown as a single element, memory 112 may comprise multiple discrete memories and/or memory types.

Memory 112 may store or otherwise include various computer readable code segments, such as may form applications, operating systems, files, electronic documents, content, etc. For example, memory 112 of the illustrated embodiment comprises computer readable code segments defining Transport Accelerator (TA) 120 and UA 129, which when executed by a processor (e.g., processor 111) provide logic circuits operable as described herein. The code segments stored by memory 112 may provide applications in addition to the aforementioned TA 120 and UA 129. For example, memory 112 may store applications such as a browser, useful in accessing content from server 130 according to embodiments herein. Such a browser can be a web browser, such as a hypertext transfer protocol (HTTP) web browser for accessing and viewing web content and for communicating via HTTP with server 130 over one or more of connections 151a-151d and connection 152, via network 150, if server 130 is a web server. As an example, an HTTP request can be sent from the browser in client device 110, over connections 151a and 152, via network 150, to server 130. A HTTP response can be sent from server 130, over connections 152 and 151a, via network 150, to the browser in client device 110.

UA 129 is operable to request and/or receive content from a server, such as server 130. UA 129 may, for example, comprise a client application or process, such as a browser, a DASH client, a HTTP Live Streaming (HLS) client, etc., that requests data, such as multimedia data, and receives the requested data for further processing and possibly for display on a display of client device 110. For example, client device 110 may execute code comprising UA 129 for playing back media, such as a standalone media playback application or a browser-based media player configured to run in an Internet browser. In operation according to embodiments, UA 129 decides which fragments or sequences of fragments of a content file to request for transfer at various points in time during a streaming content session. For example, a DASH client configuration of UA 129 may operate to decide which fragment to request from which representation of the content (e.g., high resolution representation, medium resolution representation, low resolution representation, etc.) at each point in time, such as based on recent download conditions. Likewise, a web browser configuration of UA 129 may operate to make requests for web pages, or portions thereof, etc. Typically, the UA requests such fragments using HTTP requests.

TA 120 is adapted according to the concepts herein to provide enhanced delivery of fragments or sequences of fragments of content (e.g., the aforementioned content fragments as may be used in providing video streaming, file download, web-based applications, general web pages, etc.). TA 120 of embodiments is adapted to allow a generic or legacy UA (i.e., a UA which has not been predesigned to interact with the TA) that only supports a standard interface, such as a HTTP 1.1 interface implementing standardized TCP transmission protocols, for making fragment requests to nevertheless benefit from using the TA executing those requests. Additionally or alternatively, TA 120 of embodiments provides an enhanced interface to facilitate UAs that are designed to take advantage of the functionality of the enhanced interface are provided further benefits. TA 120 of embodiments is adapted to execute fragment requests in accordance with existing content transfer protocols, such as using TCP over a HTTP interface implementing standardized TCP transmission protocols, thereby allowing a generic or legacy media server (i.e., a media server which has not been predesigned to interact with the TA) to serve the requests while providing enhanced delivery of fragments to the UA and client device.

In providing the foregoing enhanced fragment delivery functionality, TA 120 of the embodiments herein comprises architectural components and protocols as described herein. For example, TA 120 of the embodiment illustrated in FIG. 1A comprises Request Manager (RM) 121 and Connection Managers (CMs) 122a-122d which cooperate to provide various enhanced fragment delivery functionality, as described further below.

In addition to the aforementioned code segments forming applications, operating systems, files, electronic documents, content, etc., memory 112 may include or otherwise provide various registers, buffers, and storage cells used by functional block so client device 110. For example, memory 112 may comprise a play-out buffer, such as may provide a first-in/first-out (FIFO) memory for spooling data of fragments for streaming from server 130 and playback by client device 110.

Processor 111 of embodiments can be any general purpose or special purpose processor capable of executing instructions to control the operation and functionality of client device 110. Although shown as a single element, processor 111 may comprise multiple processors, or a distributed processing architecture.

I/O element 113 can include and/or be coupled to various input/output components. For example, I/O element 113 may include and/or be coupled to a display, a speaker, a microphone, a keypad, a pointing device, a touch-sensitive screen, user interface control elements, and any other devices or systems that allow a user to provide input commands and receive outputs from client device 110. Any or all such components may be utilized to provide a user interface of client device 110. Additionally or alternatively, I/O element 113 may include and/or be coupled to a disk controller, a network interface card (NIC), a radio frequency (RF) transceiver, and any other devices or systems that facilitate input and/or output functionality of client device 110.

I/O element 113 of the illustrated embodiment comprises a plurality of interfaces operable to facilitate data communication, shown as interfaces 161a-161d. The interfaces may comprise various configurations operable in accordance with a number of communication protocols. For example, interfaces 161a-161d may provide an interface to a 3G network, 4G/LTE network, a different 4G/LTE network, and WiFi communications, respectively, whereas the TA 120 uses for example a transport protocol such as HTTP/TCP, HTTP/xTCP, or a protocol built using User Datagram Protocol (UDP) to transfer data over these interfaces. Each such interface may be operable to provide one or more communication ports for implementing communication sessions, such as via an associated communication link, such as links 151a-151d shown linking the interfaces of I/O element 113 with components of network 150.

It should be appreciated that the number and configuration of interfaces utilized according to embodiments herein are not limited to that shown in FIG. 1A. Fewer or more interfaces may be utilized according to embodiments of a transport accelerator, for example. Moreover, one or more such interfaces may provide data communication other than through the network links shown (e.g., links 151a-151d) and/or with devices other than network components (e.g., server 130).

In operation to access and play streaming content according to embodiments, client device 110 communicates with server 130 via network 150, using one or more of links 151a-151d and 152, to obtain content data (e.g., as the aforementioned fragments) which, when rendered, provide playback of the content. Accordingly, UA 129 may comprise a content player application executed by processor 111 to establish a content playback environment in client device 110. When initiating playback of a particular content file, UA 129 may communicate with a content delivery platform of server 130 to obtain a content identifier (e.g., one or more lists, manifests, configuration files, or other identifiers that identify media segments or fragments, and their timing boundaries, of the content). The information regarding the media segments and their timing is used by streaming content logic of UA 129 to control requesting fragments for playback of the content.

Server 130 comprises one or more systems operable to serve content to client devices. For example, server 130 may comprise a standard HTTP web server operable to stream content to various client devices via network 150. Server 130 may include a content delivery platform comprising any system or methodology that can deliver content to user device 110. The content may be stored in one or more databases in communication with server 130, such as database 140 of the illustrated embodiment. Database 140 may be stored on server 130 or may be stored on one or more servers communicatively coupled to server 130. Content of database 140 may comprise various forms of data, such as video, audio, streaming text, and any other content that can be transferred to client device 110 over a period of time by server 130, such as live webcast content and stored media content.

Database 140 may comprise a plurality of different source or content files and/or a plurality of different representations of any particular content (e.g., high resolution representation, medium resolution representation, low resolution representation, etc.). For example, content file 141 may comprise a high resolution representation, and thus high bit rate representation when transferred, of a particular multimedia compilation while content file 142 may comprise a low resolution representation, and thus low bit rate representation when transferred, of that same particular multimedia compilation. Additionally or alternatively, the different representations of any particular content may comprise a Forward Error Correction (FEC) representation (e.g., a representation including redundant encoding of content data), such as may be provided by content file 143. A Uniform Resource Locator (URL), Uniform Resource Identifier (URI), and/or Uniform Resource Name (URN) is associated with all of these content files according to embodiments herein, and thus such URLs, URIs, and/or URNs may be utilized, perhaps with other information such as byte ranges, for identifying and accessing requested data.

Network 150 can be a wireless network, a wired network, a wide area network (WAN), a local area network (LAN), or any other network suitable for the transfer of content as described herein. Although represented as a single network cloud in FIG. 1A, it should be appreciated that network 150 may comprise one or more forms of networks, including cellular networks, radio frequency data networks, wireline networks, cable transmission system networks, optical networks, the Public Switched Telephone Network (PSTN), etc. In an embodiment, network 150 can comprise at least portions of the Internet. Client device 110 can be connected to network 150 over one or more bi-directional connections, such as is represented by network links 151a-151d. The connection can be a wired connection or can be a wireless connection. In an embodiment, links 151a-151d can provided by wireless connections, such as a cellular 4G connection, a wireless fidelity (WiFi) connection, a Bluetooth connection, or another wireless connection. Server 130 can be connected to network 150 over one or more bi-directional connections, such as represented by network connection 152. Alternatively, client device 110 can be connected via a uni-directional connection, such as that provided by a Multimedia Broadcast Multimedia System (MBMS) enabled network (e.g., connections 151, 152 and network 150 may comprise a MBMS network, and server 130 may comprise a Broadcast Multicast Service Center (BM-SC) server). Server 130 can be connected to network 150 over a uni-directional connection (e.g. a MBMS network using protocols and services as described in 3GPP TS.26.346 or an ATSC 3.0 network). The connection can be a wired connection or can be a wireless connection. Network 150 may comprise any number of components for facilitating the communications described herein, such as routers, switches, gateways, and repeaters as are well known in the art.

Client device 110 of the embodiment illustrated in FIG. 1A comprises TA 120 operable to provide enhanced delivery of fragments or sequences of fragments of content according to the concepts herein. As discussed above, TA 120 of the illustrated embodiment comprises RM 121 and CM 122 which cooperate to provide various enhanced fragment delivery functionality. Interface 124 between UA 129 and RM 121 and interface 123 between RM 121 and CM 122 of embodiments provide an HTTP-like connection. For example, the foregoing interfaces may employ standard HTTP protocols as well as including additional signaling (e.g., provided using signaling techniques similar to those of HTTP) to support certain functional aspects of enhanced fragment delivery according to embodiments herein.

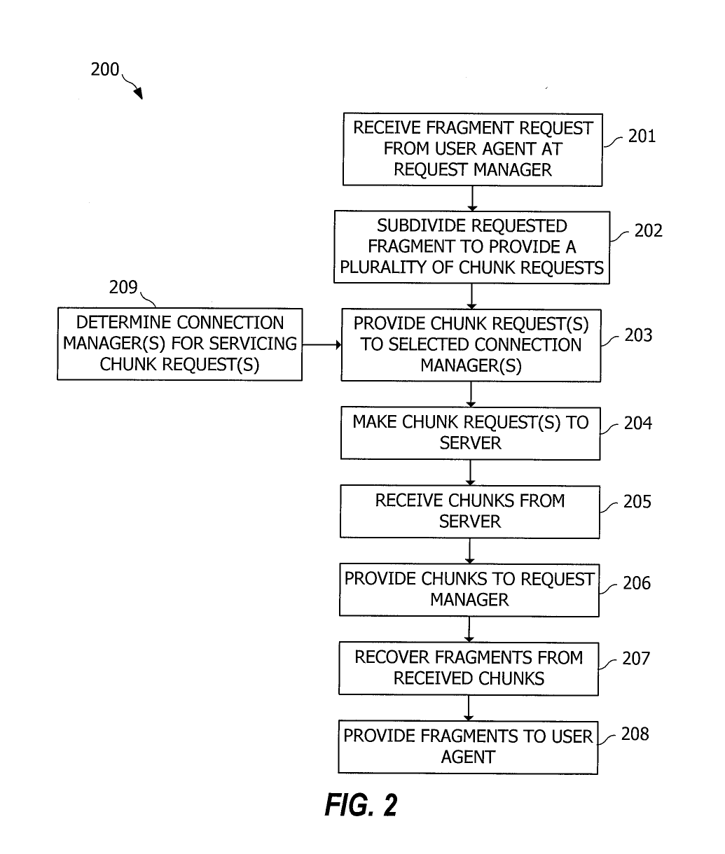

In operation according to embodiments, as illustrated by flow 200 of FIG. 2, RM 121 receives requests for fragments from UA 129 (block 201). In accordance with embodiments herein, RM 121 is adapted to receive and respond to fragment requests from a generic or legacy UA (i.e., a UA which has not been predesigned to interact with the RM), thereby providing compatibility with such legacy UAs. Accordingly, RM 121 may operate to isolate UA 129 from the enhanced content delivery operation of TA 120. However, as will be more fully understood from the discussion which follows, UA 129 may be adapted for enhanced content delivery operation, whereby RM 121 and UA 129 cooperate to implement one or more features of the enhanced content delivery operation, such as through the use of signaling between RM 121 and UA 129 for implementing such features.

TA 120 of embodiments implements data transfer using blocks or packets of content which can be smaller than the content fragments requested by the UA. Accordingly, RM 121 of embodiments operates to subdivide requested fragments (block 202) to provide a plurality of corresponding smaller data requests (referred to herein as “chunk requests” wherein the requested data comprises a “chunk”). The size of chunks requested by TA 120 of embodiments can be much less than the size of the fragment requested by UA 129. Thus, each fragment request from UA 129 may trigger RM 121 to generate and make multiple chunk requests to CM 122 to recover that fragment. Such chunk requests may comprise some form of content identifier (e.g., URL, URI, URN, etc.) of a data object comprising the fragment content, or some portion thereof, perhaps with other information, such as a byte ranges comprising the desired content chunk, whereby the chunks aggregate to provide the requested fragment.

Some of the chunk requests made by RM 121 to CM 122 may be for data already requested that has not yet arrived, and which RM 121 has deemed may never arrive or may arrive too late. Additionally or alternatively, some of the chunk requests made by RM 121 to any or all of CMs 122a-122d may be for FEC encoded data generated from the original fragment, whereby RM 121 may FEC decode the data received from the CM to recover the fragment, or some portion thereof. RM 121 delivers recovered fragments to UA 129. Accordingly, there may be various configurations of RMs according to embodiments, such as may comprise a basic RM configuration (RM-basic) which does not use FEC data and thus only requests portions of data from the original source fragments and a FEC RM configuration (RM-FEC) which can request portions of data from the original source fragments as well as matching FEC fragments generated from the source fragments.

RM 121 of embodiments may be unaware of timing and/or bandwidth availability constraints, thereby facilitating a relatively simple interface between RM 121 and any or all of CMs 122a-122d, and thus RM 121 may operate to make chunk requests without consideration of such constraints by RM 121. Alternatively, RM 121 may be adapted for awareness of timing and/or bandwidth availability constraints, such as may be supplied to RM 121 by one or more of CMs 122a-122d or other modules within client device 110, and thus RM 121 may operate to make chunk requests based upon such constraints.

RM 121 of embodiments is adapted for operation with a plurality of different CM configurations. Moreover, RM 121 of the illustrated embodiment is adapted to interface concurrently with more than one CM, such as to request data chunks of the same fragment or sequence of fragments from two or more CMs of CMs 122a-122d. Each such CM may, for example, support a different network interface (e.g., a first CM may have a local interface to an on-device cache, a second CM may use HTTP/TCP connections to a 3G network interface, a third CM may use HTTP/TCP connections to a 4G/LTE network interface, a fourth CM may use HTTP/TCP connections to a WiFi network interface, etc.).

In operation according to embodiments, RM 121 may direct chunk requests (block 203 of FIG. 2), whether for the same or different fragments requested by UAs, to one or more appropriate CM(s). For example, a RM coupled to a CM implementing xTCP techniques using HTTP/TCP connections to a 4G/LTE interface and another CM implementing HTTP/TCP connections to a WiFi interface may direct part of the data requests that are sent to the first CM and part of the data requests to the second CM. RM 121 may operate to select a particular CM or CMs of CM 122a-122d to make chunk requests to at any particular point in time based on various conditions and/or metrics, such as to avoid network congestion, optimize bandwidth utilization, implement load balancing, etc. RM 121 of embodiments may use techniques, such as round robin processing, with respect to the chunk requests within each interface to make sure fragment requests for each interface receives fair amount of chunk requests sent to the corresponding CM. RM 121 can aggregate the data received from each of the CMs (e.g., any of CMs 122a-122d used with respect to a fragment request) to reconstruct the fragment requested by UA 129 and provide the response back to the UA.

In addition to or in the alternative to logic of RM 121 selecting a particular CM or CMs of CMs 122a-122d to which the chunk requests are to be made, embodiments may utilize one or more functional blocks other than the RM to provide such chunk request control. For example, embodiments may implement interface manager logic, such as within or coupled to interface 123 between RM 121 and CM 122a-122d to select a CM or CMs of CM 122a-122d to make chunk requests to at any particular point in time.

From the foregoing, it can be appreciated that the illustrated embodiment of TA 120 illustrated in FIGS. 1A and 1B facilitates the use of multiple interfaces for serving fragment requests through the use of multiple CMs (e.g., one CM per interface). For example, the CMs provided according to embodiments may facilitate interfaces including, but not limited to, 3G, 4G/LTE, WiFi, and local caches.

In operation according to embodiments, each of CM 122a-122d interfaces with RM 121 to receive chunk requests, and sends those requests over network 150 (block 204 of FIG. 2). The CMs receive the responses to their chunk requests (block 205) and pass the responses back to RM 121 (block 206), wherein the fragments requested by UA 129 are resolved from the received chunks by RM 121 (block 207) and provided to UA 129 (block 208). Functionality of each CM of CMs 122a-122d of embodiments operates to decide when to request data of the chunk requests made by RM 121. In accordance with embodiments herein, one or more CMs of CMs 122a-122d is adapted to request and receive chunks from generic or legacy servers (i.e., a server which has not been predesigned to interact with the CA). For example, the server(s) from which CMs 122a-122d requests the data may comprise standard HTTP web servers.

As with RM 121 discussed above, there may be various configurations of CMs provided as any or all of CMs 122a-122d according to embodiments. For example, a multiple connection CM configuration (e.g., CM-mHTTP) may be provided whereby the CM is adapted to use HTTP over multiple TCP connections. A multiple connection CM configuration may operate to dynamically vary the number of connections (e.g., TCP connections), such as depending upon network conditions, demand for data, congestion window, etc. As another example, an extended transmission protocol CM configuration (e.g., CM-xTCP) may be provided wherein the CM uses HTTP on top of an extended form of a TCP connection (referred to herein as xTCP). Such an extended transmission protocol may provide operation adapted to facilitate enhanced delivery of fragments by TA 120 according to the concepts herein. For example, an embodiment of xTCP provides acknowledgments back to the server even when sent packets are lost (in contrast to the duplicate acknowledgement scheme of TCP when packets are lost). Such a xTCP data packet acknowledgment scheme may be utilized by TA 120 to avoid the server reducing the rate at which data packets are transmitted in response to determining that data packets are missing. As still another example, a proprietary protocol CM configuration (e.g., CM-rUDP) wherein the CM uses a proprietary User Datagram Protocol (UDP) protocol and the rate of sending response data from a server may be at a constant preconfigured rate, or there may be rate management within the protocol to ensure that the send rate is as high as possible without undesirably congesting the network. Such a proprietary protocol CM may operate in cooperation with proprietary servers that support the proprietary protocol.

It should be appreciated that, although the illustrated embodiment has been discussed with respect to CMs 122a-122d requesting data from source files from server 130, the source files may be available on servers or may be stored locally on the client device, depending on the type of interface the CM has to access the data. For example, an embodiment of TA 120, as shown in FIG. 1B, may provide an interface (e.g., interface 161e) for providing communications with respect to a local resource (e.g., local cache 170), such as may store one or more source or content files and/or a plurality of different representations of any particular content (e.g., content files 171 and 172), via a local data link (e.g., link 151e).

Further, in accordance with embodiments, client device 110 may be able to connect to one or more other devices (e.g., various configurations of devices disposed nearby), referred to herein as helper devices (e.g., over a WiFi or Bluetooth interface), wherein such helper devices may have connectivity to one or more servers, such as server 130, through a 3G or LTE connection, potentially through different carriers for the different helper devices. Thus, client device 110 may be able to use the connectivity of the helper devices to send chunk requests to one or more servers, such as server 130. In this case, there may be a CM within TA 120 to connect to and send chunk requests and receive responses to each of the helper devices. In such an embodiment, the helper devices may send different chunk request for the same fragment to the same or different servers (e.g., the same fragment may be available to the helper devices on multiple servers, where for example the different servers are provided by the same of different content delivery network providers).

FIG. 1C shows detail with respect to embodiments of RM 121 and CM 122 as may be implemented with respect to configurations of TA 120 as illustrated in FIGS. 1A and 1B. In particular, RM 121 is shown as including request queues (RQs) 191a-191c, request scheduler 192 (including request chunking algorithm 193), and reordering layer 194. CM 122 is shown as including Tvalue manager 195, readiness calculator 196, and request receiver/monitor 197. It should be appreciated that, although particular functional blocks are shown with respect to the embodiments of RM 121 and CM 122 illustrated in FIG. 1C, additional or alternative functional blocks may be implemented for performing functionality according to embodiments as described herein.

RQs 191a-191c are provided in the embodiment of RM 121 illustrated in FIG. 1C to provide queuing of requests received by TA 120 by one or more UAs (e.g., UA 129). The different RQs of the plurality of RQs shown in the illustrated embodiment may be utilized for providing queuing with respect to various requests. For example, different ones of the RQs may each be associated with different levels of request priority (e.g., live streaming media requests may receive highest priority, while streaming media receives lower priority, and web page content receives still lower priority). Similarly, different ones of the RQs may each be associated with different UAs, different types of UAs, etc. It should be appreciated that, although three such queues are represented in the illustrated embodiment, embodiments herein may comprise any number of such RQs.

Request scheduler 192 of embodiments implements one or more scheduling algorithms for scheduling fragment requests and/or chunk requests in accordance with the concepts herein. For example, logic of request scheduler 192 may operate to determine whether the RM is ready for another fragment request based upon when the amount of data received or requested but not yet received for that fragment falls below some threshold amount, when the RM has no already received fragment requests for which the RM can make another chunk request, etc. Additionally or alternatively, logic of request scheduler 192 may operate to determine whether a chunk request is to be made to provide an aggregate download rate of the connections which is approximately the maximum download rate possible given current network conditions, to result in the amount of data buffered in the network is as small as possible, etc. Request scheduler 192 may, for example, operate to query the CM for chunk request readiness, such whenever the RM receives a new data download request from the UA, whenever the RM successfully issues a chunk request to the CM to check for continued readiness to issue more requests for the same or different origin servers, whenever data download is completed for an already issued chunk request, etc.

Request scheduler 192 of the illustrated embodiment is shown to include fragment request chunking functionality in the form of request chunking algorithm 193. Request chunking algorithm 193 of embodiments provides logic utilized to subdivide requested fragments to provide a plurality of corresponding smaller data requests. The above referenced patent application entitled “TRANSPORT ACCELERATOR IMPLEMENTING REQUEST MANAGER AND CONNECTION MANAGER FUNCTIONALITY” provides additional detail with respect to computing an appropriate chunk size according to embodiments as may be implemented by request chunking algorithm 193.

Reordering layer 194 of embodiments provides logic for reconstructing the requested fragments from the chunks provided in response to the aforementioned chunk requests. It should be appreciated that the chunks of data provided in response to the chunk requests may be received by TA 120 out of order, and thus logic of reordering layer 194 may operate to reorder the data, perhaps making requests for missing data, to thereby provide requested data fragments for providing to the requesting UA(s).

Tvalue manager 195 of the illustrated embodiment of CM 122 provides logic for determining and/or managing one or more parameters (e.g., threshold parameter, etc.) for providing control with respect to chunk requests (e.g., determining when a chunk request is to be made). Similarly, readiness calculator 196 of the illustrated embodiment of CM 122 provides logic for determining and/or managing one or more parameters (e.g., download rate parameters) for providing control with respect to chunk requests (e.g., signaling readiness for a next chunk request between CM 122 and RM 121). Detail with respect to the calculation of such parameters and their use according to embodiments is provided in the above reference patent application entitled “TRANSPORT ACCELERATOR IMPLEMENTING REQUEST MANAGER AND CONNECTION MANAGER FUNCTIONALITY.”

Request receiver/monitor 197 of embodiments provides logic operable to manage chunk requests. For example, request receiver/monitor 197 may operate to receive chunk requests from RM 121, to monitor the status of chunk requests made to one or more content servers, and to receive data chunks provided in response to the chunk requests.

FIG. 1D shows detail with respect to embodiments of interface 123 as may be implemented between a RM (e.g., RM 121) and one or more CMs (e.g., CM 122f and 122g) with respect to configurations of TA 120 as illustrated in FIGS. 1A and 1B. It should be appreciated that the configuration of RM 121 illustrated in FIG. 1D corresponds to that shown in FIG. 1C above. Similarly, the configuration of CM 122f and 122g illustrated in FIG. 1D corresponds to that of CM 122 shown in FIG. 1C above, wherein Tvalue managers 195f and 195g, readiness calculators 196f and 196g, and request receiver/monitors 197f and 197g of CMs 122f and 122g, respectively, corresponding to Tvalue manager 195, readiness calculator 196, and request receiver/monitor 197 of CM 122 shown in FIG. 1C. Interface 123 of the embodiment illustrated in FIG. 1D, however, includes interface manager (IM) 180 providing logic operable to select a CM or CMs of CM 122a-122d to make chunk requests to at any particular point in time, such as based on various conditions and/or metrics, such as to avoid network congestion, optimize bandwidth utilization, implement load balancing, etc.

IM 180 of the illustrated embodiment is shown as including interface selection 181 and interface monitor 182. In operation according to embodiments, interface monitor 182 keeps track of the state (availability, performance, etc.) of each interface, and interface selection 181 determines which interface to use for the immediate next request. In operation according to alternative embodiments, each CM may be bound to an interface, whereby each CM indicates to the RM when it is ready for another chunk request and the RM supplies chunk requests for each fragment to whichever CM signals it is ready. In such an embodiment, interface monitor 182 may operate to keep track of the state of each interface and, having a CM assigned to each available interface where the CM signals readiness for another request to the RM, the RM prepares the chunk request and makes it to a CM that is ready.

As can be appreciated from the foregoing, RM 121 of embodiments may interface with more than one CM, as expressly shown in the embodiments of FIGS. 1A, 1B, and 1C. Such CMs may, for example, support a different network interface (e.g., CM 122a may use HTTP/TCP connections to a 3G network interface, CM 122b may use 4G/LTE connections to a UDP network interface, CM 122c may use HTTP/TCP, Stream Control Transmission Protocol (SCTP), UDP, etc. connections to a different 4G/LTE network interface, CM 122d may use HTTP/TCP, SCTP, UDP, etc. connections to a WiFi network interface, CM 122e may use a local interface (e.g., data bus, Universal Serial Bus (USB), disk interface, etc.) to on-device cache 170, etc.). Additionally or alternatively, such CMs may provide network interfaces which are similar in nature (e.g. different WiFi links).

It should be appreciated that operation of a transport accelerator may be adapted for use with respect to particular interfaces. For example, an embodiment of a CM implemented according to the concepts herein may operate to be very aggressive with respect to chunk requests when the network interface is 3G/4G/LTE, knowing that the bottleneck is typically the radio access network that is governed by a PFAIR (Proportionate FAIRness) queuing policy that will not be harmful to other User Equipment (UEs) using the network. Correspondingly, embodiments may implement a less aggressive CM when the network interface is over a shared WiFi public access network, which uses a FIFO queuing policy that would be potentially harmful to other less aggressive UEs using the network. Where data is accessed from local storage (e.g., as may have been queued from an earlier broadcast), as opposed to being obtained through a network connection to a content server, embodiments of a transport accelerator may implement a CM adapted for accessing data from a local cache that is a very different design than that used with respect to network connections.

Where RM 121 interfaces concurrently with the multiple CMs, the RM may be operable to request data chunks of the same fragment or sequence of fragments from a plurality of CMs. For example, an embodiment of TA 120 may operate such that part of the chunk requests are sent to a first CM-xTCP that uses HTTP/TCP connections to a 4G/LTE interface and part of the chunk requests are sent to a second CM-mHTTP that uses HTTP/TCP connections to a WiFi interface. Logic of RM 121 may intelligently decide how much of a fragment and/or chunk request should be made over any particular interface versus any other interface (e.g., to provide network congestion avoidance, optimize bandwidth utilization, implement load balancing, etc.). As an example, where the WiFi connection is providing a data rate that is twice as fast as that of the 4G interface, RM 121 may operate to make a larger number of the chunk requests (e.g., twice the number of chunk requests) over the WiFi interface (e.g., interface 161d via CM 122d) as compared to the 4G interface (e.g., interface 161c via cm 122c). The RM can aggregate the data received from each of the CMs to reconstruct the fragment requested by the UA and provide the response back to the UA.

In another example operational situation, an embodiment of TA 120 may operate such that part of the chunk requests are sent to a first CM that uses a local connection to a cache and part of the chunk requests are sent to one or more of a second CM-xTCP that uses HTTP/TCP connections to a 4G/LTE interface and a third CM-mHTTP that uses HTTP/TCP connections to a WiFi interface. Where the local cache has only partial content (e.g., where evolved Multimedia Broadcast Multicast Service (eMBMS) is used to broadcast content for storage and later playback by client devices, the client device may have missed some of the broadcast), logic of RM 121 may operate to make requests for chunks to the first CM for the data that is present in the local cache and to make requests for chunks to either or both of the second and third CM (e.g., using unicast connections) for the data that is missing from the local cache. RM 121 can aggregate the data received from these different sources to reconstruct the fragment requested by UA 129 and provide the response back to the UA.

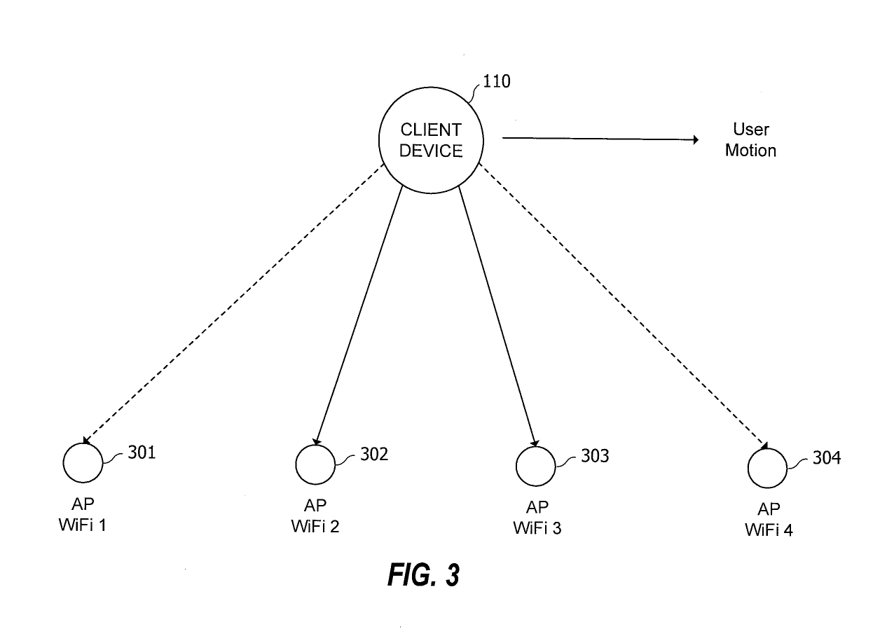

As still another example operational situation, an embodiment of TA 120 may operate to provide some of the chunk requests to particular CMs as the corresponding networks become available or otherwise satisfactory for transferring content. Accordingly, RM 121 may use several available network interfaces, wherein the network interfaces might be similar in nature (e.g. different WiFi links) or they might be different (e.g. a WiFi link and mobile data), whereby selection of the network interfaces for requesting chunks is changed as conditions change (e.g., as client device 110 moves into and out of different network coverage areas). An example of such operation is represented in FIG. 3, wherein client device 110 is moving through the coverage areas associated with WiFi Access Points (APs) 301-304. By selection of appropriate ones of the CMs to make chunk requests, RM 121 can access various networks as client device 110 moves along. Accordingly, AP Wifi 2 302 (e.g., via a first CM and corresponding interface) and AP Wifi 3 303 (e.g., via a second CM and corresponding interface) are in use at the moment illustrated in FIG. 3, AP Wifi 1 301 is no longer in use (e.g., a third CM and/or corresponding interface may be searching for another suitable, available WiFi AP), and AP Wifi 4 304 will soon become accessible (e.g., a fourth CM and/or corresponding interface may be establishing a link with a suitable, available WiFi AP which has come into range). In this scenario, client device 110 may operate to use 2 WiFi links at a time, while changing the links being used while moving. RM 121 may, for example, receive a readiness signal from any of the CMs and use that to send the next request to that CM. When a CM needs to shut down (e.g., has lost its connection with an AP), the RM may issue its remaining requests to another CM or CMs, thereby switching transparently to a new network connection. Thus, in operation according to embodiments, the use of different and changing network paths is transparent to the UA, and handled seamlessly by the TA. Furthermore, the methods described herein using the TA that allow downloading the same content (streaming or download) over multiple interfaces either concurrently or dynamically changing over time, or both, avoids many of the issues associated with migration of connections at lower layers to support similar functionality. For example, methods that migrate TCP connections from one WiFi access point to another, or from on LTE network to another, or from WiFi to LTE, or split the data flow for a TCP connection over multiple interfaces, all require coordination between the different networks, servers, or endpoints of such TCP connections in order to operate, which is often difficult to implement. In contrast, the TA methods described herein do not require any such coordination, and can be implemented with existing networks and serving infrastructure.

Although embodiments illustrated in FIGS. 1A and 1B show RM 121 interfaced with a single UA, the concepts herein are applicable to other configurations. For example, a single RM may be adapted for use with respect to a plurality of UAs, whereby the RM is adapted to settle any contention for the connections resulting from the concurrent operation of the UAs.

Additionally or alternatively, although the CMs of the embodiments illustrated in FIGS. 1A and 1B are shown interfaced with a single instance of RM 121, the CMs of some embodiments may interface concurrently with more than one such RM. For example, multiple RMs, each for a different UA of client device 110, may be adapted to use the same CM or CMs, whereby the CMs may be adapted to settle any contention for the connections resulting from concurrent operation of the RMs. Accordingly, Multiple UAs may be served according to embodiments by sharing a same RM operating in cooperation with a plurality of CMs or a plurality of RMs (e.g., one for each UA) each operating in cooperation with a plurality of CMs.

Embodiments may implement one or more proxies with respect to the different connections to content servers to facilitate enhanced download of content. For example, embodiments may comprise one or more Transport Accelerator proxies (TA proxies) disposed between one or more User Agents and a content server. Such TA proxy configurations may be provided according to embodiments to facilitate Transport Accelerator functionality with respect to a client device to obtain content via links with content server(s) on behalf of the client device, thereby facilitating delivery of high quality content. For example, existing UAs may establish connections to a TA proxy and send all of their requests for data through the TA and receive all of the replies via the TA to thereby receive the advantages and benefits of TA operation without specifically implementing changes at the UA for such TA operation. Accordingly, a TA proxy may comprise an application that provides a communication interface proxy (e.g., a HTTP proxy) taking requests from a UA (e.g., UA 129), or several UAs for content transfer. The TA proxy may implement an infrastructure including RM and CM functionality, as described above, whereby the requests are sent to one or more RMs, which will then generate chunk requests for one or more corresponding CMs. The TA proxy of embodiments will further collect the chunk responses, and produce a response to the appropriate UA. It should be appreciated that a UA utilizing such a TA proxy may comprise any application that receives data via a protocol supported by the TA proxy (e.g., HTTP), such as a DASH client, a web browser, etc.

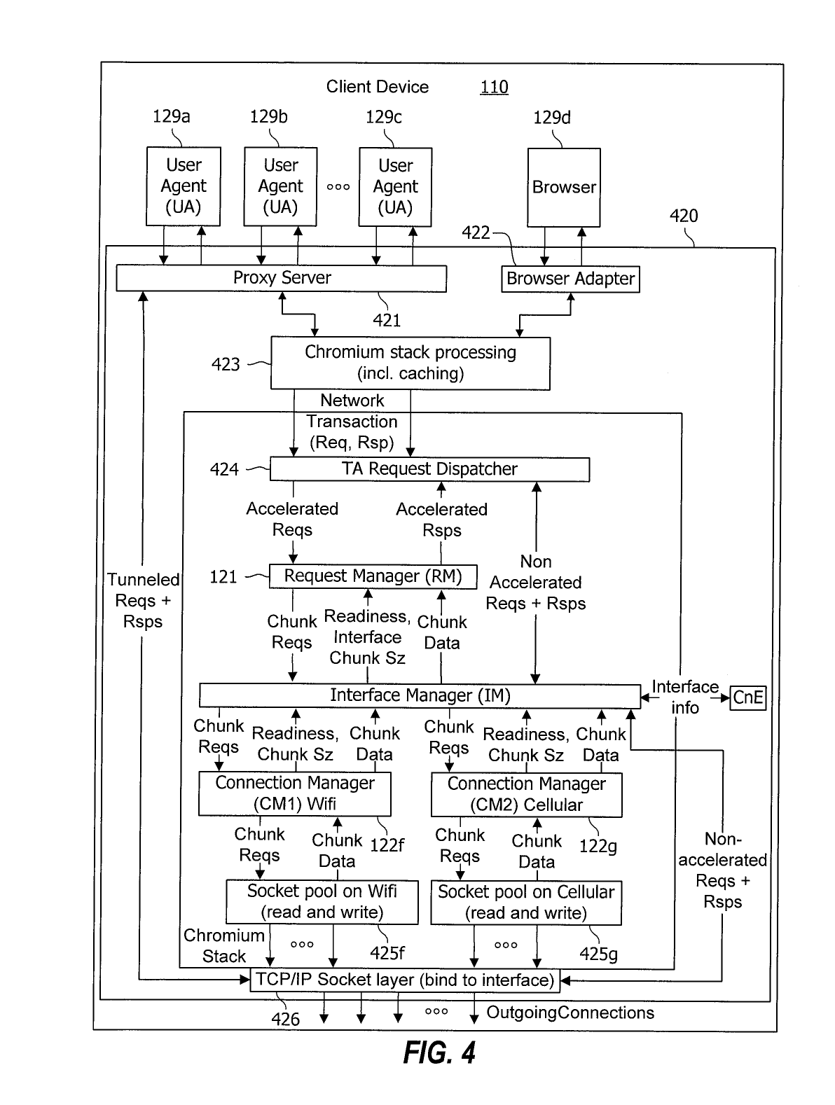

FIG. 4 illustrates an embodiment implementing a Transport Accelerator proxy, shown as TA proxy 420, with respect to client device 110. It should be appreciated that, although TA proxy 420 is illustrated as being deployed within client device 110, TA proxies of embodiments may be deployed in different configurations, such as being hosted (whether wholly or in part) by a device in communication with a client device to which transport accelerator functionality is to be provided.

The illustrated embodiment of TA proxy 420 includes RM 121 and multiple CMs, shown here as CM 122f and CM 122g, operable to generate chunk requests and manage the requests made to one or more servers for content, as described above. Moreover, TA proxy 420 of the illustrated embodiment includes additional functionality facilitating proxied transport accelerator operation on behalf of one or more UAs according to the concepts herein. For example, TA proxy 420 is shown to include proxy server 421 providing a proxy server interface with respect to UAs 129a-129c. Although a plurality of UAs are shown in communication with proxy server 421 in order to illustrate support of multiple UA operation, it should be appreciated that embodiments may provide transport accelerator proxied operation with respect to any number of user agents (e.g., one or more).

UAs 129a-129c may interface with TA 420 operable as a proxy to one or more content servers. In operation according to embodiments, proxy server 421 interacts with UAs 129a-129c as if the respective UA is interacting with a content server hosting content. The transport accelerator operation, including the chunking of fragment requests, managing requests from the content server(s), assembling fragments from chunks, etc., is provided transparently with respect to UAs 129a-129c. Accordingly, these UAs may comprise various client applications or processes executing on client device 110 which are not specifically adapted for operation with transport accelerator functionality, and nevertheless obtain the benefits of transport accelerator operation.

Proxy server 421 is shown as being adapted to support network connections with respect to the UAs which are not compatible with or otherwise well suited for transport accelerator operation. For example, a path is provided between proxy server 421 and socket layer 426 to facilitate bypassing transport accelerator operation with respect to data of certain connections, such as tunneled connections making requests for content and receiving data sent in response thereto.

TA proxy 420 of the illustrated embodiment is also shown to include browser adapter 422 providing a web server interface with respect to UA 129d, wherein UA 129d is shown as a browser type user agent (e.g., a HTTP web browser for accessing and viewing web content and for communicating via HTTP with web servers). Although a single UA is shown in communication with browser adapter 422, it should be appreciated that embodiments may provide transport accelerator proxied operation with respect to any number of user agents (e.g., one or more).

In operation according to embodiments, browser adapter 422 interacts with UA 129d, presenting a consolidated HTTP interface to the browser. As with the proxy server described above, the transport accelerator operation, including the chunking of fragment requests, managing requests from the content server(s), assembling fragments from chunks, etc., is provided transparently with respect to UA 129d. Accordingly, this UA may comprise a browser executing on client device 110 which is not specifically adapted for operation with transport accelerator functionality, and nevertheless obtain the benefits of transport accelerator operation.

In addition to the aforementioned functional blocks providing a proxy interface with respect to UAs, the embodiment of TA 420 illustrated in FIG. 4 is shown including additional functional blocks useful in facilitating accelerated transport of content according to the concepts herein. In particular, TA 420 is shown as including stack processing 423, TA request dispatcher 424, stack processing 425f and 425g, socket layer 426, and IM 180. Stack processing 423 of embodiments provides network stack processing with respect to the fragment requests made by the UA, whereby the fragment requests traverse the layers of the network stack for providing the data of the request in a form suitable for processing by transport accelerator logic and for providing response data in a form expected by the requesting UA. TA request dispatcher 424 of embodiments decides if a given HTTP request should be accelerated using the TA or if it should be handled as a single un-accelerated HTTP get request. Stack processing 425f and 425g of embodiments provides network stack processing with respect to the chunk requests made by the CM, whereby the data of the chunk requests traverses the layers of the network stack for providing the chunk requests in a form suitable for network communication and for providing response data in a form suitable for processing by transport accelerator logic. Socket layer 426 of embodiments provides one or more socket APIs for interfacing with input/output elements (e.g., I/O element 113) facilitating network data connections. IM 180 of embodiments provides logic operable to select a CM or CMs of CM 122a-122d to make chunk requests to at any particular point in time, such as based on various conditions and/or metrics, such as to avoid network congestion, optimize bandwidth utilization, implement load balancing, etc. Additionally or alternatively, logic of IM 180 may be utilized to keep track of the state of each interface and, having a CM assigned to each available interface where the CM signals readiness for another request to the RM, the RM prepares the chunk request and makes it to a CM that is ready.

A TA proxy of embodiments herein operates to schedule requests in such a way to provide fairness with respect to different UAs that may be utilizing the TA proxy. Accordingly, where a TA proxy serves a plurality of UAs, the TA proxy may be adapted to implement request scheduling so as not to stall one UA in favor of others (i.e., the TA proxy attempts to implement fairness with respect to the different UAs). A TA proxy may, for example, schedule requests in a way so to be as fair as possible to the different UAs. A TA proxy serving a plurality of UAs may thus apply logic to be fair among the UAs. For example, a bad user experience would be provided in the situation where there are two DASH client UAs and one client played at a very high rate while the other client stalled completely. Operation where the clients are both sharing the bandwidth available equally or proportionately to their demand may therefore be desirable.

Assume, for example, that there are two UAs, A and B, connected to a TA proxy, and that an operational goal of the TA proxy is to process N requests concurrently (i.e., have N requests sent over the network at any point in time). Thus, the TA proxy of embodiments may operate to issue new chunk requests on behalf of UA A, only if there are no chunk requests that could be issued on behalf of UA B, or if the number of incomplete chunk requests for UA A is less than N/2. More generally, where there are k UAs for which the TA proxy could issue requests, then the TA proxy of embodiments would issue requests only for those UAs for which less than N/k requests were already issued. It should be appreciated that, in the foregoing example, it is assumed that the TA proxy knows which requests belong to which UA. However, for a standard HTTP proxy, this is not necessarily the case. Accordingly, a TA proxy of embodiments herein may operate to assume that each connection belongs to a different application and/or to assume requests with the same User Agent strings belong to the same UA.

Although the illustrated embodiment of TA proxy 420 is shown adapted for proxied operation with respect to a plurality of different user agent configurations (e.g., general UAs using proxy server 421 and the specific case of browser UAs using browser adapter 422) in order to illustrate the flexibility and adaptability of the transport accelerator platform, it should be appreciated that TA proxies of embodiments may be configured differently. For example, a TA proxy configuration may be provided having only a proxy server or browser adapter, thereby supporting respective UA configurations, according to embodiments.

TA proxies may additionally or alternatively be adapted to operate in accordance with priority information, if such information is available, with respect to requests for one or more UAs being served thereby. Priority information might, for example, be provided in an HTTP header used for this purpose, and a default priority might be assigned otherwise. Furthermore, some applications may have a default value which depends on other meta information on the request, for example the request size and the mime type of the resource requested (e.g., very small requests are frequently meta-data requests, such as requests for the segment index, and it may thus be desirable to prioritize those requests higher than media requests in the setting of a DASH player). As another example, in the case of a web browser application it may be desirable to prioritize HTML files over graphics images, since HTML files are likely to be relatively small and to contain references to further resources that need to be also downloaded, whereas the same is not typically the case for image files.

In operation according to embodiments, for each fragment request, the RM of a TA proxy may issue several chunk requests (possibly including requests for FEC data, as described above). At the point in time where enough response data has been received so that the whole fragment data can be reconstructed, the RM of embodiments reconstructs the fragment data (possibly by FEC decoding). The TA proxy of embodiments may then construct a suitable HTTP response header and send the HTTP response header to the UA, followed by the fragment data.

Additionally or alternatively, a TA proxy may operate to deliver parts of the response earlier; before a complete fragment response can be reconstructed, thereby reducing the latency of the initial response. Since a media player does not necessarily need the complete fragment to commence its play out, such an approach may allow a player to start playing out earlier, and to reduce the probability of a stall. In such operation, however, the TA proxy may want to deliver data back to the UA when not all response headers are known. In an exemplary scenario, a server may respond with a Set-Cookie header (e.g., the server may respond in such a way in every chunk request), but it is undesirable for the TA proxy to wait until every response to every chunk request is seen before sending data to the UA. In operation according to embodiments, the TA proxy may start sending the response using chunked transfer encoding, thereby enabling appending headers at the end of the message. In the particular case of Cookies, the Set-Cookie header would be stripped from the response in the TA proxy at first, and the values stored away, according to embodiments. With each new Set-Cookie header seen, the TA proxy of such an embodiment would update its values of the cookie and, at the end of the transmission (e.g., in the chunked header trailer), the TA proxy would send the final Set-Cookie headers.

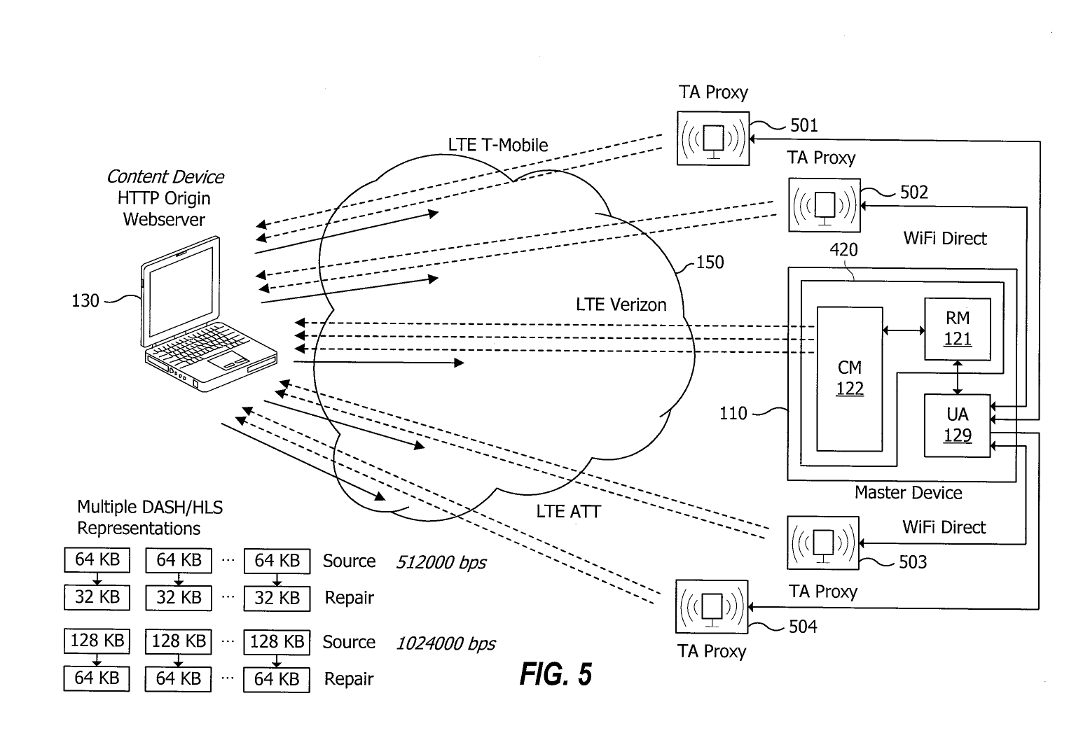

Embodiments may implement a plurality of proxies with respect to the different connections to content servers to provide for download of content. A plurality of such TA proxies may be provided, such as shown in FIG. 5 as TA proxies 420 and 501-504, whereby the content obtained by any or all of the TA proxies may be aggregated to provide requested fragments to the User Agent. Such TA proxies may, for example, be utilized by embodiments herein to operate independently and/or cooperatively (e.g., using one or more CMs and/or RMs Transport Accelerator functionality) to obtain content via links with content server(s) on behalf of the client device, thereby facilitating delivery of high quality content. In a variation of a TA proxy configuration the transferred content of any particular content file may be aggregated and provided to appropriate ones of the slave devices (e.g., TA proxy host devices) for their consumption, such as to provide playback of a media file (e.g., using players of the slave devices).

From the foregoing, it can be appreciated that TA proxies 501-503 of the illustrated embodiment may comprise a TA configuration substantially corresponding to that of TA proxy 420 and TA 120 described above, having one or more Request Managers (e.g. operable as discussed above with respect to RM 121) and one or more Connection Managers (e.g., operable as discussed above with respect to CMs 122a-122e). Such a TA proxy may be hosted on any of a number of devices, whether the client device itself or devices in communication therewith (e.g., “slave devices” such as peer user devices, server systems, etc.). Communications between UA 129 of client device 110 and a TA proxy of TA proxies 501-504 which is hosted on a remote device may be provided using any of a number of suitable communication links which may be established therebetween. For example, UA 129 of embodiments may utilize WiFi direct links (e.g., using HTTP communications) providing peer-to-peer communication between client device 110 and the device hosting a TA proxy. The TA proxies may utilize various communication links between the TA proxy and server, such as may comprise 3G, 4G, LTE, LTE-U, WiFi, etc. It should be appreciated that such proxied links may be the same or different than communications links supported by client device 110 directly.

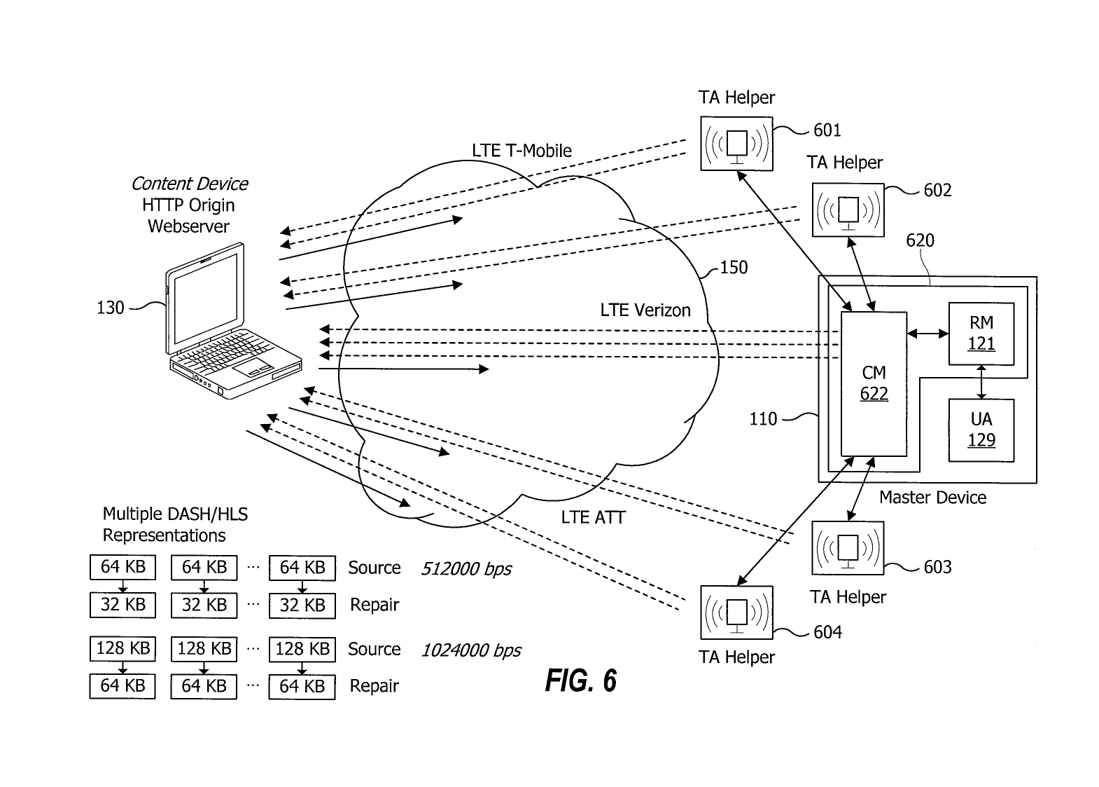

FIG. 6 shows another example implementation of a multiple CM configuration in accordance with the concepts herein. In the embodiment illustrated in FIG. 6, the User Agent is in communication with TA 620 operable to provide transport acceleration functionality in accordance with the concepts herein. TA 620 of embodiments may comprise a TA configuration substantially corresponding to that of TA proxy 420 and/or TA 120 described above, having one or more Request Managers (e.g. operable as discussed above with respect to RM 121) and one or more Connection Managers (e.g., operable as discussed above with respect to CMs 122a-122e). Such a TA may be hosted on any of a number of devices, whether the client device itself or devices in communication therewith.

TA 620 of the illustrated embodiment is shown as including CM pool 622, such as may comprise a plurality of CMs (e.g., CM122a-122d). In a configuration of TA 620, CMs of CM pool 622 are adapted for cooperative operation with a CM of a helper device (e.g., a respective one of TA helpers 601-604), wherein a helper device may include a CM providing connectivity to one or more content servers. That is, there may be a CM within TA 620 to connect to and send chunk requests and receive responses to each of the helper devices. Accordingly, client device 110 of FIG. 6 is able to connect to one or more helper devices (e.g., various configurations of devices disposed nearby), such as over a WiFi or Bluetooth interface. Such helper devices of embodiments provide connectivity to one or more servers, such as server 130, through a 3G, 4G, LTE, or other connection, potentially through different carriers for the different helper devices. Thus, client device 110 of FIG. 6 is able to use the connectivity of the helper devices to send chunk requests to one or more servers, such as server 130. In such embodiments, the helper devices may send different chunk request for the same fragment to the same or different servers (e.g., the same fragment may be available to the helper devices on multiple servers, where for example the different servers are provided by the same of different content delivery network providers).

In operation according to embodiments, the Transport Accelerator functionality provided with respect to helper devices, such as TA helpers 601-604, accepts chunk requests from one or more CMs of a master device (e.g., a CM of CM pool 622, then issuing these chunk requests over their other interface and receiving the responses to pass back to the master device. The Transport Accelerator functionality of the master device (e.g., TA 620) may operate to aggregate the responses from one or more such TAs helper device to reconstruct the fragment and provide it to the UA.

Although selected aspects have been illustrated and described in detail, it will be understood that various substitutions and alterations may be made therein without departing from the spirit and scope of the present invention, as defined by the following claims.

What is claimed is:

1. A method for accelerating, by a transport accelerator (TA) of a client device, delivery of content to a user agent (UA) of the client device, the method comprising:
initiating media transmission operation for the UA using the TA disposed in a communication path between the UA and a content server operable to provide content, wherein the TA comprises a request manager (RM) operable to control what data is requested from the content server and a plurality of connection managers (CMs) operable to control when the data is requested from the content server, wherein each CM of the plurality of CMs is adapted for communication with the content server via a different communication interface;
requesting, by the RM, one or more chunks of the content from a first CM of the plurality of CMs; and
receiving, by the RM, data sent in response to the requesting one or more chunks of the content from the first CM.

2. The method of claim 1, wherein the different communication interfaces comprise at least two interfaces selected from the group consisting of a Long Term Evolution (LTE) interface, a fourth generation cellular (4G) interface, and a WiFi interface.

3. The method of claim 1, wherein the different communication interfaces comprise communication interfaces providing data communication using different communications protocols.

4. The method of claim 3, wherein the different communications protocols include at least two communications protocols selected from the group consisting of a protocol based on Transport Control Protocol (TCP) and a protocol based on User Datagram Protocol (UDP).

5. The method of claim 1, wherein the different communication interfaces comprise different instances of communication interfaces using a same communications protocol.

6. The method of claim 1, wherein at least one CM of the plurality of CMs is adapted to communicate with the content server using multiple Transport Control Protocol (TCP) connections.

7. The method of claim 1, further comprising:
selecting, by the RM, the first CM for requesting the one or more chunks of the content based upon perceived congestion of a network associated with a communication interface of the different communication interfaces.

8. The method of claim 1, further comprising:
selecting, by the RM, the first CM for requesting the one or more chunks of the content for distributing chunk requests across a plurality of different connections.

9. The method of claim 1, further comprising:
selecting, by the RM, the first CM for requesting the one or more chunks of the content for implementing load balancing with respect to the plurality of CMs.

10. The method of claim 9, further comprising:
requesting, by the RM, another one or more chunks of the content from a second CM of the plurality of CMs;
receiving, by the RM, data sent in response to the requesting another one or more chunks of the content from the second CM; and
aggregating, by the RM, the data provided in response to the requesting one or more chunks of the content from the first CM and the data provided in response to the requesting one or more chunks of content from the second CM to provide a fragment of the content requested by the UA.

11. The method of claim 9, further comprising:
distributing the chunk requests across the plurality of the different interfaces in accordance with congestion perceived on two or more networks associated with corresponding two or more communication interfaces of the different communication interfaces.

12. The method of claim 1, wherein at least one CM of the plurality of CMs comprises a part of a proxy in communication with the content server via an interface of the different communication interfaces associated with the at least one CM.

13. The method of claim 12, wherein the proxy comprises an application that is an HTTP proxy receiving one or more fragment requests from one or more UAs including the UA, subdividing each fragment request using a RM of the proxy, passing the subdivided requests to the at least one CM, and providing each requested fragment with an HTTP header to the UA.

14. An apparatus configured for accelerating, by a transport accelerator (TA) of a client device, delivery of content to a user agent (UA) of the client device, the apparatus comprising:
means for initiating media transmission operation for the UA using the TA disposed in a communication path between the UA and a content server operable to provide content, wherein the TA comprises a request manager (RM) operable to control what data is requested from the content server and a plurality of connection managers (CMs) operable to control when the data is requested from the content server, wherein each CM of the plurality of CMs is adapted for communication with the content server via a different communication interface;
means for requesting, by the RM, one or more chunks of the content from a first CM of the plurality of CMs; and
means for receiving, by the RM, data sent in response to the requesting one or more chunks of the content from the first CM.

15. The apparatus of claim 14, wherein the different communication interfaces comprise at least two interfaces selected from the group consisting of a Long Term Evolution (LTE) interface, a fourth generation cellular (4G) interface, and a WiFi interface.

16. The apparatus of claim 14, wherein the different communication interfaces comprise communication interfaces providing data communication using different communications protocols.

17. The apparatus of claim 16, wherein the different communications protocols include at least two communications protocols selected from the group consisting of a protocol based on Transport Control Protocol (TCP) and a protocol based on User Datagram Protocol (UDP).

18. The apparatus of claim 14, wherein the different communication interfaces comprise different instances of communication interfaces using a same communications protocol.

19. The apparatus of claim 14, wherein at least one CM of the plurality of CMs is adapted to communicate with the content server using multiple Transport Control Protocol (TCP) connections.

20. The apparatus of claim 14, further comprising:
means for selecting, by the RM, the first CM for requesting the one or more chunks of the content based upon perceived congestion of a network associated with a communication interface of the different communication interfaces.

21. The apparatus of claim 14, further comprising:
means for selecting, by the RM, the first CM for requesting the one or more chunks of the content for distributing chunk requests across a plurality of different connections.

22. The apparatus of claim 14, further comprising:
means for selecting, by the RM, the first CM for requesting the one or more chunks of the content for implementing load balancing with respect to the plurality of CMs.

23. The apparatus of claim 22, further comprising:
means for requesting, by the RM, another one or more chunks of the content from a second CM of the plurality of CMs;
means for receiving, by the RM, data sent in response to the requesting another one or more chunks of the content from the second CM; and
means for aggregating, by the RM, the data provided in response to requesting one or more chunks of the content from the first CM and the data provided in response to requesting one or more chunks of content from the second CM to provide a fragment of the content requested by the UA.

24. The apparatus of claim 22, further comprising:
means for distributing the chunk requests across the plurality of the different interfaces in accordance with congestion perceived on two or more networks associated with corresponding two or more communication interfaces of the different communication interfaces.

25. The apparatus of claim 14, wherein at least one CM of the plurality of CMs comprises a part of a proxy in communication with the content server via an interface of the different communication interfaces associated with the at least one CM.

26. The apparatus of claim 25, wherein the proxy comprises an application that is a HTTP proxy configured to receive one or more fragment requests from one or more UAs including the UA, subdivide each fragment request using a RM of the proxy, passing the subdivided requests to the at least one CM, and provide each requested fragment with an HTTP header to the UA.

27. A computer program product for accelerating, by a transport accelerator (TA) of a client device, delivery of content to a user agent (UA) of the client device, the computer program product comprising:
a non-transitory computer-readable medium having program code recorded thereon, the program code including:
program code to initiate media transmission operation for the UA using the TA disposed in a communication path between the UA and a content server operable to provide content, wherein the TA comprises a request manager (RM) operable to control what data is requested from the content server and a plurality of connection managers (CMs) operable to control when the data is requested from the content server, wherein each CM of the plurality of CMs is adapted for communication with the content server via a different communication interface;
program code to request, by the RM, one or more chunks of the content from a first CM of the plurality of CMs; and
program code to receive, by the RM, data sent in response to the requesting one or more chunks of the content from the first CM.

28. The computer program product of claim 27, wherein the different communication interfaces comprise at least two interfaces selected from the group consisting of a Long Term Evolution (LTE) interface, a fourth generation cellular (4G) interface, and a WiFi interface.

29. The computer program product of claim 27, wherein the different communication interfaces comprise communication interfaces providing data communication using different communications protocols.

30. The computer program product of claim 27, wherein the different communication interfaces comprise different instances of communication interfaces using a same communications protocol.

31. The computer program product of claim 27, further comprising:
requesting, by the RM, another one or more chunks of the content from a second CM of the plurality of CMs;
receiving, by the RM, data sent in response to the requesting another one or more chunks of the content from the second CM; and
aggregating, by the RM, the data provided in response to the requesting one or more chunks of the content from the first CM and the data provided in response to the requesting one or more chunks of content from the second CM to provide a fragment of the content requested by the UA.

32. An apparatus configured for accelerating, by a transport accelerator (TA) of a client device, delivery of content to a user agent (UA) of the client device, the apparatus comprising:
at least one processor; and
a memory coupled to the at least one processor,
wherein the at least one processor is configured:
to initiate media transmission operation for the UA using the TA disposed in a communication path between the UA and a content server operable to provide content, wherein the TA comprises a request manager (RM) operable to control what data is requested from the content server and a plurality of connection managers (CMs) operable to control when the data is requested from the content server, wherein each CM of the plurality of CMs is adapted for communication with the content server via a different communication interface;
to request, by the RM, one or more chunks of the content from a first CM of the plurality of CMs; and
to receive, by the RM, data sent in response to the requesting one or more chunks of the content from the first CM.

33. The apparatus of claim 32, wherein the different communication interfaces comprise at least two interfaces selected from the group consisting of a Long Term Evolution (LTE) interface, a fourth generation cellular (4G) interface, and a WiFi interface.

34. The apparatus of claim 32, wherein the different communication interfaces comprise communication interfaces providing data communication using different communications protocols.

35. The apparatus of claim 34, wherein the different communications protocols include at least two communications protocols selected from the group consisting of a protocol based on Transport Control Protocol (TCP) and a protocol based on User Datagram Protocol (UDP).

36. The apparatus of claim 32, wherein the different communication interfaces comprise different instances of communication interfaces using a same communications protocol.

37. The apparatus of claim 32, wherein the at least one processor is further configured:
to request, by the RM, another one or more chunks of the content from a second CM of the plurality of CMs;
to receive, by the RM, data sent in response to the requesting another one or more chunks of the content from the second CM; and
to aggregate, by the RM, the data provided in response to the requesting one or more chunks of the content from the first CM and the data provided in response to the requesting one or more chunks of content from the second CM to provide a fragment of the content requested by the UA.
